(19) United States
(12) Patent Application Publication
(10) Pub. No.: US 2016/0017710 A1
(43) Pub. Date: Jan. 21, 2016

(54) LUMP CRUSHER FOR A SCRAPER CHAIN CONVEYOR

(71) Applicant: CATERPILLAR GLOBAL MINING EUROPE GMBH, Lünen (DE)

(72) Inventors: Bernhard WLEKLINSKI, Werne (DE); Eugen BAIER, Schwelm (DE); Christoph PIETRALA, Dortmund (DE)

(73) Assignee: Caterpillar Global Mining Europe GmbH, Lünen (DE)

(21) Appl. No.: 14/773,949

(22) PCT Filed: Sep. 12, 2013
(86) PCT No.: PCT/EP2013/002743

§ 371 Date: Sep. 9, 2015

(30) Foreign Application Priority Data
Mar. 15, 2013 (DE) 20 2013 002 583.2

(51) Int. Cl. E21F 13/06; E21F 13/00; B65G 19/08

(52) U.S. Cl. CPC E21F 13/066; B65G 19/08; E21F 13/002

(57) ABSTRACT

A coarse crusher for use at both face ends of a face conveyor in an underground mine is disclosed. The coarse crusher may have a pan module with a strand segment for guiding an endless conveying means. The strand segment may be delimited by a first pan outer longitudinal side and a second pan outer longitudinal side which lies opposite the first pan outer longitudinal side. The first pan outer longitudinal side and the second pan outer longitudinal side may have a plurality of first pan fastening apparatuses. The coarse crusher may further have a base-frame module fastened releasably via the corresponding first pan fastening apparatuses to one of the first pan outer longitudinal side and the second pan outer longitudinal side. The coarse crusher may also have a support-arm module fastened releasably to the base-frame module.

### TECHNICAL FIELD

The present disclosure relates to coarse crushers for comminuting extracted material. In particular, the present disclosure relates to coarse crushers for crushing lumps of rock in an underground mine.

### BACKGROUND

In underground mines, conveyors are used to transport extracted rock. What are known as crushers may be used to crush lumps of rock. For example, said crushers may be integrated into a conveyor, with the result that lumps of rock may be comminuted in the running conveying flow.

Coarse crushers are used to comminute large lumps of rock while still at the face before the transfer to a gate conveyor. To this end, a coarse crusher may be integrated, for example, directly into a face conveyor which extends along a longwall face in front of a working face.

The present disclosure is directed, at least in part, to improving or overcoming one or more aspects of prior systems.

### SUMMARY OF THE DISCLOSURE

According to a first aspect of the present disclosure, a coarse crusher for use at both face ends of a face conveyor in an underground mine is disclosed. The coarse crusher may comprise a pan module with a strand segment for guiding an endless conveying means. The strand segment may be delimited laterally by a first pan outer longitudinal side and a second pan outer longitudinal side which lies opposite the first pan outer longitudinal side. Both the first pan outer longitudinal side and the second pan outer longitudinal side may include a plurality of first pan fastening apparatuses. The coarse crusher may further comprise a base-frame module which, depending on the face end of the face conveyor, into which face end the coarse crusher is to be integrated, is fastened releasably via the corresponding first pan fastening apparatuses to that first or second pan outer longitudinal side which faces away from a working face, and a support-arm module fastened releasably to the base-frame module. Other features and aspects of this disclosure will be apparent from the following description and the accompanying drawings.

Other features and aspects of the present disclosure result from the following description and the associated drawings.

### BRIEF DESCRIPTION OF THE DRAWINGS

The accompanying drawings, which are incorporated herein and constitute a part of the specification, illustrate exemplary embodiments of the disclosure and, together with the description, serve to explain the principles of the disclosure. In the drawings:

FIG. 1 shows a mining system 1 disclosed by way of example in longwall mining operation in an underground mine;

FIG. 2 shows a coarse crusher disclosed by way of example;

FIG. 3 shows a first side view of a pan module disclosed by way of example;

FIG. 4 shows a second side view of the pan module disclosed by way of example;

FIG. 5 shows a first side view of a base-frame module disclosed by way of example;

FIG. 6 shows a second side view of the base-frame module disclosed by way of example;

FIG. 7 shows a first side view of a support-arm module disclosed by way of example; and

FIG. 8 shows a second side view of the support-arm module disclosed by way of example.

### DETAILED DESCRIPTION

The following is a detailed description of exemplary embodiments of the present disclosure. The exemplary embodiments described therein and illustrated in the drawings are intended to teach the principles of the present disclosure, enabling those of ordinary skill in the art to implement and use the present disclosure in many different environments and for many different applications. Therefore, the exemplary embodiments are not intended to be, and should not be considered as, a limiting description of the scope of patent protection. Rather, the scope of patent protection shall be defined by the appended claims.

The present disclosure is based partially on the finding that a modular coarse crusher, as disclosed herein, may be configured to be integrated both at a first face end of a face conveyor and at a second face end of the face conveyor. This may reduce the outlay for realizing mirror-image arrangements of the mining system.

Furthermore, the present disclosure is based partially on the finding that a modular design of a coarse crusher with releasable fastening means of the individual modules may simplify the replacement, the maintenance and the access to the individual modules.

Still further, the present disclosure is based partially on the finding that a guide segment for guiding an extraction machine may be fastened releasably to a pan module at the face end of the face conveyor, with the result that the extraction machine may cut free the transition between face and gate.

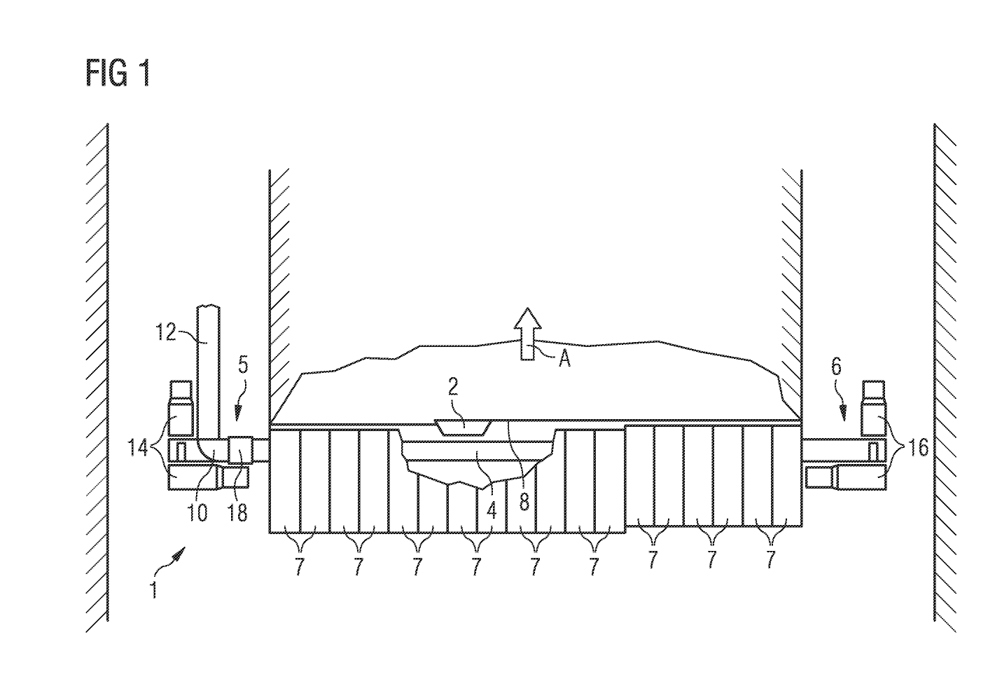

In the following, first of all the installation environment of a coarse crusher will be described in greater detail. An exemplary mining system 1 is shown in FIG. 1. For the purpose of coal mining in an underground mine, the mining system 1 comprises an extraction machine 2, a face conveyor 4 and a plurality of shield supports 7.

The extraction machine 2 is guided in a guide on the face conveyor 4 on the side of the coal face. During operation, the extraction machine 2 moves along the working face 8 and extracts coal in the process. The extraction machine 2 may be, for example, a mining plow or a shearer-loader.

The coal which is extracted by the extraction machine 2 falls onto the face conveyor 4 or is pushed onto the latter by the extraction machine 2. The face conveyor 4 extends between a first face end 5 and a second face end 6 which lies opposite the first face end 5. Lumps of coal and rock which are extracted by the extraction machine 2 are transported out of the face by the face conveyor 4.

For example, the face conveyor 4 may be a chain scraper conveyor (armored face conveyor). A chain scraper conveyor of this type has two pan sections which lie above one another. The upper pan section is called the upper strand and forms the conveying strand. The lower pan section is called the lower strand and forms the return strand. An endless conveying means comprising a conveyor chain with flights which are also called chain scrapers runs around the upper strand and the lower strand continuously during operation.

During operation, the face conveyor 4 transports the lumps of coal and rock to a transfer point 10. At said transfer point 10, the extracted material is transferred to a gate conveyor 12. In the embodiment shown of the mining system 1, the transfer point 10 is arranged at the first face end 5 of the face conveyor 4. In other embodiments, the transfer point 10 onto the gate conveyor 12 may also be arranged at the second face end 6 of the face conveyor 4, the gate conveyor 12 then also being arranged at the second face end 6.

A main drive 14 and an auxiliary drive 16 are provided for driving the face conveyor 4.

The shield supports 7 are positioned next to one another in order to hold open the face area in front of the working face 8. The shield supports 7 advance alternately or in groups during every pass of the extraction machine 2. The continuously excavated working face 8 in the mining direction (arrow A in FIG. 1) is followed by this advancing. In the process, the face conveyor 4 is likewise advanced in the direction of the working face 8, and therefore also the extraction machine 2 which is guided on the face conveyor 4. What is known as the waste area is situated behind the shield supports 7.

A coarse crusher 18 is provided for the comminution of the lumps of rock and coal which are transported on the face conveyor 4. The comminution of the material before transfer to the gate conveyor 12 may assist, for example, in keeping the transfer point 10 free from excessively large lumps of material. As a result, the risk of the transfer point 10 becoming clogged by an increasing accumulation of material may be reduced. The coarse crusher 18 is integrated into the face conveyor 4, as will be described in detail later.

In the embodiment which is shown, the coarse crusher 18 is arranged at the first face end 5 of the face conveyor 4. In other embodiments, the coarse crusher 18 may also be arranged at the second face end 6 of the face conveyor 4 if the transfer point 10 is also arranged at the second face end 5. Herein, reference is made to these cases with the designation “mirror-image arrangement”.

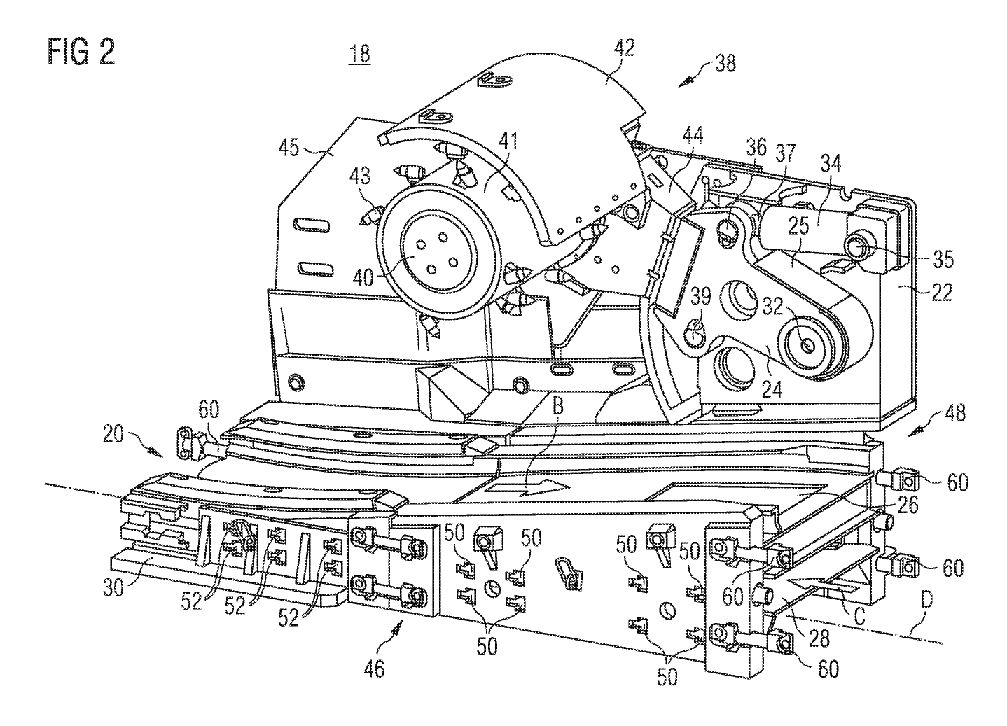

In the following, an exemplary coarse crusher 18 will be described in greater detail. FIG. 2 shows an exemplary coarse crusher 18 of this type having a pan module 20, a base-frame module 22 and a support-arm module 24.

The pan module 20 has a strand segment 26, 28 with an upper strand segment 26 and a lower strand segment 28. As has already been described in conjunction with FIG. 1, said strand segments serve to guide an endless conveying means. The upper strand segment 26 and the lower strand segment 28 in each case form a section of the entire upper strand and the entire lower strand, respectively, of the face conveyor 4 (see FIG. 1). During operation, an endless conveying means is guided in the upper strand segment 26 in the material transport direction B, and the endless conveying means is guided in the lower strand segment 28 in a return direction C which is directed counter to the material transport direction B.

The strand segment 26, 28 extend along a pan longitudinal axis D and is delimited laterally with regard to the pan longitudinal axis D by a first pan outer longitudinal side 46 (shown in the foreground in FIG. 2) and a second pan outer longitudinal side 48 (concealed in FIG. 2) which lies opposite the first pan outer longitudinal side 46.

In the embodiment which is shown, the pan module 20 is substantially wedge-shaped. This wedge shape makes it possible, if the coarse crusher 18 is connected directly upstream of the transfer point 10, that the respectively set height of the transfer point 10 which depends, for example, on the geometric dimensions of the chain sprockets for deflecting the conveyor chain may be achieved by the pan module 20. As an alternative, the pan module 20 may have a different shape, such as a planar shape. The respective shape may be selected, for example, depending on the respective installation environment of the coarse crusher 18.

A guide segment 30 is fastened releasably to the pan module 20 on the first pan outer longitudinal side 46 and the base-frame module 22 is fastened releasably to the pan module 20 on the second pan outer longitudinal side 48. The releasable fastening may be realized, for example, via a plurality of screw/nut connections, plug-in wedge connections and/or hook connections.

The guide segment 30 is configured for guiding the extraction machine 2 (see FIG. 1).

The base-frame module 22, the front frame outer longitudinal side of which is shown in a transparent form in FIG. 2 for the purpose of improved illustration, may be a welded construction, just like the pan module 20 may be.

A support-arm module 24 is fastened in the base-frame module 22. By way of example, the support-arm module 24 may be fastened pivotably via a first pivot pin 32 in the base-frame module 22. Here, the pivot pin 32 is mounted rotatably in a receiving hole in the base-frame module 22 and/or in a receiving hole through a support-arm body 25 of the support-arm module 24. As an alternative or in addition, the support-arm module 24 may be fastened in a guide in the base-frame module 22, for example in a height-adjustable manner. The support-arm module 24 may be fastened pivotably, for example, on one side via the first pivot pin 32 on an inner side of the base-frame module 22 or on both sides via the first pivot pin 32 between two inner sides of the base-frame module 22 which are spaced apart.

A hydraulic cylinder 34 is provided in order to make the pivoting of the support-arm module 24 possible. A piston rod 37 is guided in the hydraulic cylinder 34. At one end which is not guided in the hydraulic cylinder 34, the piston rod 37 is fastened pivotably via a second pivot pin 36 to the support-arm module 24. One end of the hydraulic cylinder 34 is fastened pivotably via a third pivot pin 35 to the base-frame module 22. If therefore the piston rod 37 extends, for example, the support-arm module 24 will pivot downwards, the hydraulic cylinder 34 will likewise pivot downwards.

A cutting drum apparatus 38 is fastened releasably to the support-arm module 24. The cutting drum apparatus 38 is formed from a cutting drum 40, a protective plate 42 and a support 44. A plurality of picks 43 for comminuting lumps of rock and coal are fastened on a circumferential face 41 of the cutting drum 40. An electric motor and a gear mechanism, for example, may be accommodated in the support 44, which electric motor and gear mechanism are configured to drive (to rotate) the cutting drum 40. In addition, a swinging plate (not shown) may be fastened to the protective plate 42. In the embodiment shown of the coarse crusher 18, the cutting drum 40 rotates counter to the clockwise direction.

In addition, as shown, an end-side plate 45 may be fastened releasably to the pan module 20 on the second pan outer longitudinal side 48.

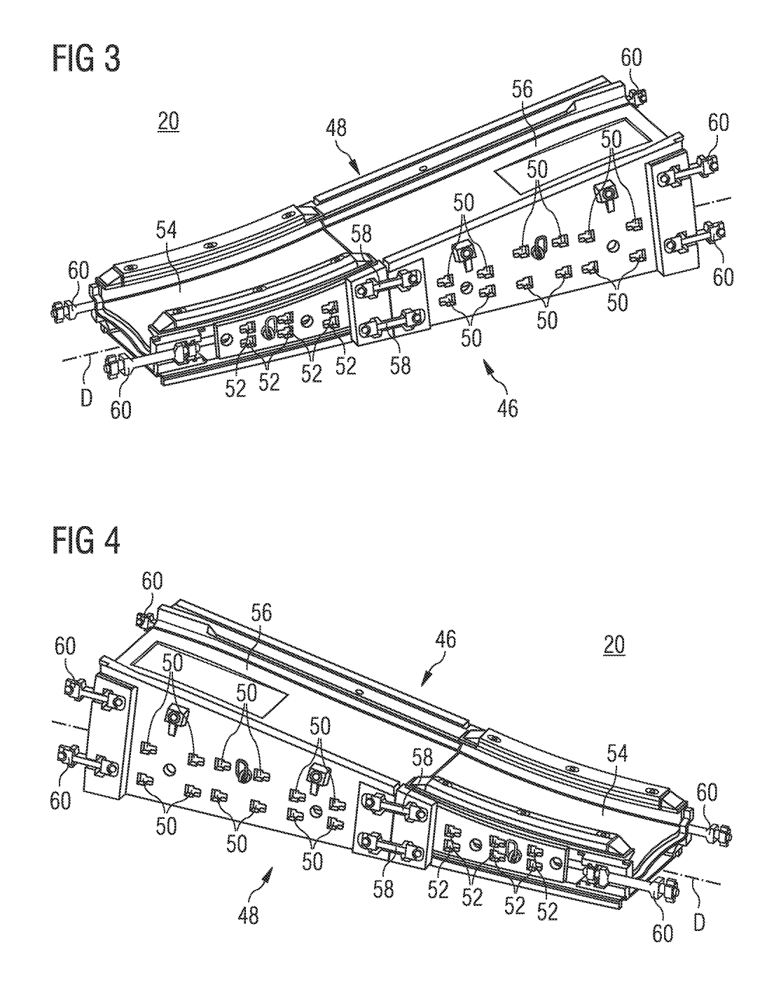

The described embodiment of the coarse crusher 18 is constructed in such a way that the first pan outer longitudinal side 46 with the guide segment 30 faces the working face 8 (in relation to FIG. 1) or is arranged on the side of the coal face. In contrast, the second pan outer longitudinal side 48 with the releasably fastened base-frame module 22 faces away from the working face 8 (in relation to FIG. 1). In other words, the second pan outer longitudinal side 48 faces what is known as the waste area or is arranged on the backfill side. As will be shown in the following, in particular, with reference to FIGS. 3 and 4, a mirror-image construction (in a mirror-image arrangement) of the coarse crusher 18 is likewise possible, however, in which the first pan outer longitudinal side 46 with the base-frame module 22 faces away from the working face 8, and the second pan outer longitudinal side 48 with the guide segment 30 faces the working face 8.

Moreover, the coarse crusher 18 may have a water spray system (not shown) which is fastened, for example, to the base-frame module 22 and is directed at the pan module 20, with the result that excessive dust development during the comminution of material by the coarse crusher 18 may be counteracted.

With reference to FIGS. 3 and 4 which show two different longitudinal side views of the pan module 20, in the following the fastening possibilities to the pan module 20, in particular, will be described more precisely. Here, FIG. 3 shows a view of the pan module 20 on a first pan outer longitudinal side 46, whereas FIG. 4 shows a view of the pan module 20 on a second pan outer longitudinal side 48.

As can be gathered by viewing FIGS. 3 and 4 together, both pan outer longitudinal sides 46, 48 have a plurality of first pan fastening apparatuses 50 which are configured as openings for screws in the exemplary embodiment which is shown. The base-frame module 22 may be fastened releasably (in relation to FIG. 2) to the said first pan fastening apparatuses 50, for example via releasable screw connections. In other words, the base-frame module 22 may optionally be fastened releasably either to the first pan outer longitudinal side 46 or to the second pan outer longitudinal side 48 via the corresponding first pan fastening apparatuses 50.

The two pan outer longitudinal sides 46, 48 may likewise have a plurality of second pan fastening apparatuses 52 which are configured as openings for screws in the exemplary embodiment which is shown. The guide segment 30 may be fastened releasably (in relation to FIG. 2) to the said second pan fastening apparatuses 52, for example via releasable screw connections. In other words, the guide segment 30 may be fastened releasably optionally either to the first pan outer longitudinal side 46 or to the second pan outer longitudinal side 48 via the corresponding second pan fastening apparatuses 52.

In one embodiment, the first pan fastening apparatuses 50 of the first pan outer longitudinal side 46 of the pan module 20 and the first pan fastening apparatuses 50 of the second pan outer longitudinal side 46 of the pan module 20 may be arranged substantially mirror-symmetrically. The mirror symmetry relates to a vertical plane of symmetry, in which the pan longitudinal axis D extends.

As an alternative or in addition, the second pan fastening apparatuses 52 of the first pan outer longitudinal side 46 of the pan module 20 and the second pan fastening apparatuses 52 of the second pan outer longitudinal side 48 of the pan module 20 may be arranged substantially mirror-symmetrically.

In one embodiment, the first pan outer longitudinal side 46 of the pan module 20 and the second pan outer longitudinal side 48 of the pan module 20 may be of substantially mirror-symmetrical configuration.

In the embodiment which is shown, the pan module 20 is formed from a first pan (pan front part) 54 and a second pan (pan rear part) 56. The pan front part 54 is connected to the pan rear part 56 via a plurality of first coupling hooks 58. In other embodiments, the pan module 20 may be, for example, of single-piece configuration, or may be formed from three or more parts.

The pan module 20 may be integrated into a face conveyor 4 (see FIG. 1) via suitable connecting means. In the exemplary pan module 20, the connection to the connection segments of the face conveyor 4 or the transfer point 10 of the face conveyor 4 may be realized via a plurality of second coupling hook connections 60. In other embodiments, additional or alternative connections may be used, in particular connections of the type which make a flexible coupling between the segments possible.

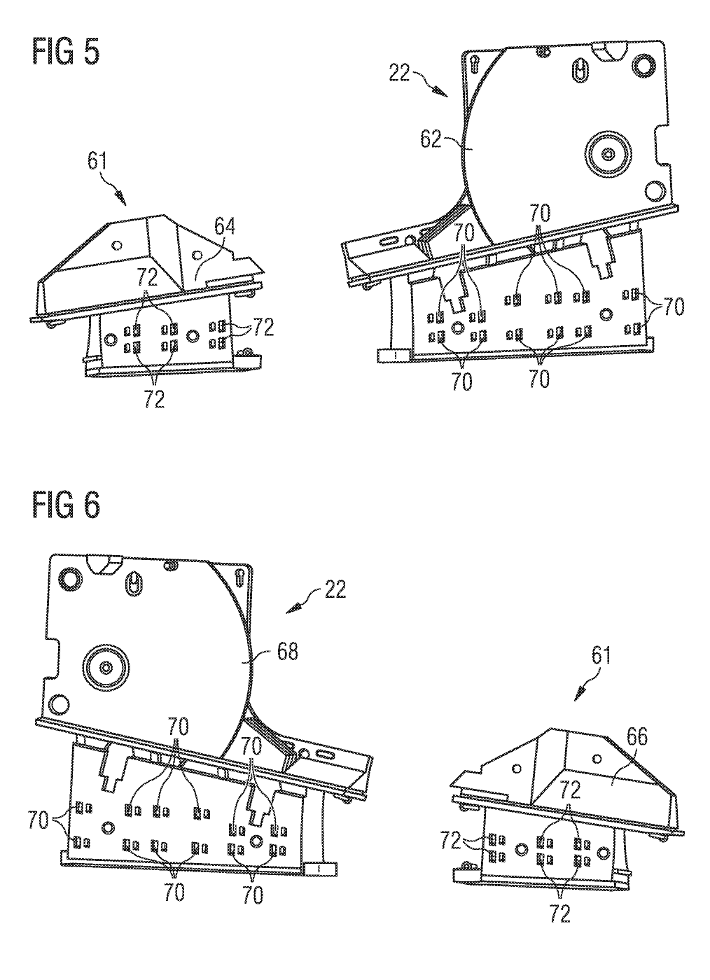

In the following, the base-frame module 22 will be described in greater detail with reference to FIGS. 5 and 6. In addition, FIGS. 5 and 6 show an additional-frame module 61. FIGS. 5 and 6 show the base-frame module 22 and the additional-frame module 61 in two different side views.

The base-frame body of the base-frame module 22 is delimited laterally by a first base-frame outer longitudinal side 62 and a second base-frame outer longitudinal side 64. A plurality of frame fastening apparatuses 70, for example openings for screws, are provided on both base-frame outer longitudinal sides 62, 68 of the base-frame module 22. The base-frame module 22 may be fastened releasably to the pan module 20 (see FIGS. 2 to 4) via the frame fastening apparatuses 70. In principle, both the base-frame outer longitudinal sides 62, 68 may be connected via the respective frame fastening apparatuses to the corresponding first pan fastening apparatuses 50 of the respective pan outer longitudinal side 46, 48 (see FIGS. 3 and 4) of the pan module 20.

In other embodiments, a plurality of frame fastening apparatuses 70 for fastening the base-frame module 22 releasably to the pan module 20 may be provided only on one base-frame outer longitudinal side 62 or 68 of the base-frame module 22.

In one embodiment, the frame fastening apparatuses 70 of the first base-frame outer longitudinal side 62 and the frame fastening apparatuses 70 of the second base-frame outer longitudinal side 68 may be arranged substantially mirror-symmetrically.

In one embodiment, in addition, the first base-frame outer longitudinal side 62 and the second base-frame outer longitudinal side 68 may be of substantially mirror-symmetrical configuration.

The additional-frame module 61 has a first additional-frame outer longitudinal side 64 and a second additional-frame outer longitudinal side 66. A plurality of additional-frame fastening apparatuses 72 are provided both on the first additional-frame outer longitudinal side 64 and on the second additional-frame outer longitudinal side 66, via which additional-frame fastening apparatuses 72 the additional-frame module 61 may be fastened to the second pan fastening apparatuses 52 on the pan module 20 (see FIGS. 3 and 4).

In one embodiment, the additional-frame fastening apparatuses 72 of the first additional-frame outer longitudinal side 64 and the additional-frame fastening apparatuses 72 of the second additional-frame outer longitudinal side 66 may be arranged substantially mirror-symmetrically.

In one embodiment, in addition, the first additional-frame outer longitudinal side 64 and the second additional-frame outer longitudinal side 66 may be of substantially mirror-symmetrical configuration.

In other embodiments, a plurality of additional-frame fastening apparatuses 72 for fastening the additional-frame module 61 releasably to the pan module 20 may be provided only on one additional-frame outer longitudinal side 64 or 66 of the additional-frame module 61.

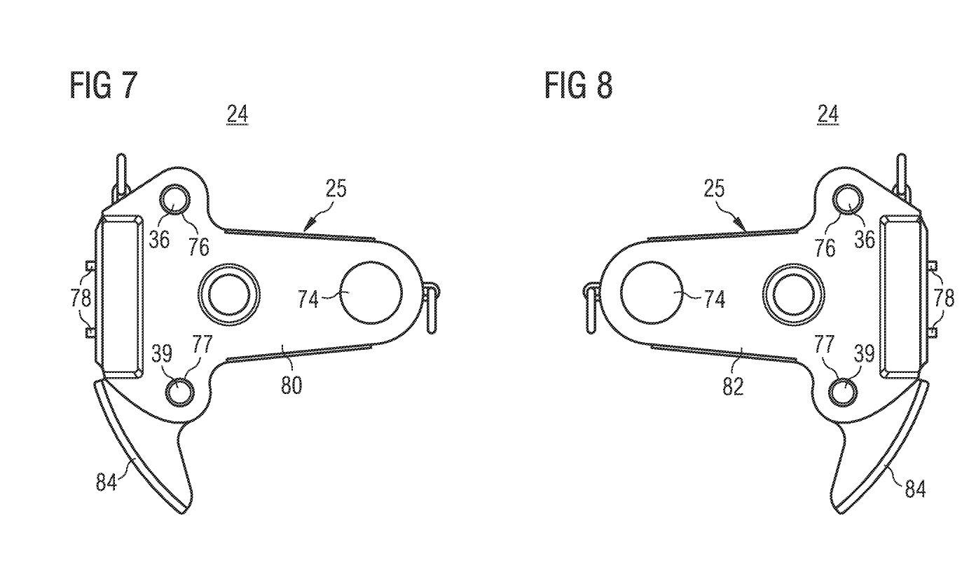

In the following, the support-arm module 24 will be described in greater detail with reference to FIGS. 7 and 8.

The support-arm body 25 (see FIG. 2) is delimited by a first support-arm outer longitudinal side 80 and a second support-arm outer longitudinal side 82 which lies opposite the first support-arm outer longitudinal side 80. A first through hole 74 extends through the support-arm body 25 from the first support-arm outer longitudinal side 80 to the second support-arm outer longitudinal side 82. The first through hole 74 is configured for receiving the first pivot pin 32 (see FIG. 2).

A second through hole 76 extends through the support-arm body 25 from the first support-arm outer longitudinal side 80 to the second support-arm outer longitudinal side 82. The second through hole 76 is configured for receiving the second pivot pin 36. The second through-hole is arranged by way of example in a section of the support-arm module 24 which is remote from a section of the support-arm module 24, through which section the first through hole 74 extends. The spacing may lie, for example, in a range between one quarter of the overall length of the support-arm module 24 and up to three quarters of the entire length of the support-arm module 24.

A third through hole 77 extends through the support-arm body 25 from the first support-arm outer longitudinal side 80 to the second support-arm outer longitudinal side 82. The third through hole 77 is configured for receiving a forth pivot pin 39 for pivotably fastening the support-arm module 24 to a piston rod. The third through hole is arranged by way of example in a section of the support-arm module 24 which is remote from a section of the support-arm module 24, through which section the first through hole 74 extends. The spacing may lie, for example, in a range between one quarter of the overall length of the support-arm module 24 and up to three quarters of the overall length of the support-arm module 24.

The second and third through holes 76, 77 are situated on regions of the support-arm module 24 which lie opposite one another. As a result, the support-arm module 24 may be used on either side. A pivotable coupling to a piston rod 37 of a hydraulic cylinder 34 may thus be realized either via the second pivot pin 36 in the second through hole 76 or via the third pivot pin 37 in the third through hole 77. The upper side and the lower side of the support-arm module 24 are therefore defined in accordance with the installation position of the support-arm module 24 in the base-frame module 22.

A protective shield 84 may be attached releasably to the support-arm module 24 on either side, with the result that it extends downwards from the side which represents the lower side of the support-arm module 24. The protective shield 84 may reduce penetration of dirt and comminuted material into the base frame (see FIG. 2).

A cutting drum apparatus 38 (see FIG. 2) may be fastened releasably via connection components 78 to the support-arm module 24. The connection components 78 are arranged at that end of the support-arm module 24 which lies opposite that end of the support-arm module 24, through which the first through hole 74 extends.

In one embodiment, the first support-arm outer longitudinal side 80 and the second support-arm outer longitudinal side 82 may be of substantially mirror-symmetrical configuration.

### INDUSTRIAL APPLICABILITY

In the following, the method of operation of the coarse crusher 18 which is disclosed by way of example in an underground mine will be explained in greater detail with reference to FIGS. 1 to 8.

The coarse crusher 20 may be constructed, for example, as shown in FIG. 2. The described modular construction of the coarse crusher 18 secondly also makes a mirror-image construction of the coarse crusher 18 possible if it is to be added in a mirror-image arrangement with respect to that of FIG. 1. In other words, depending on the face end 5 or 6 of the face conveyor 4, into which face end 5 or 6 the coarse crusher 18 is to be integrated, the coarse crusher 18 may always be mounted in such a way that the base-frame module 22 is fastened releasably to that first or second pan outer longitudinal side 46, 48 of the pan module 20 which faces away from the working face 8. In addition, the guide segment 30 may be fastened releasably to that first or second pan outer longitudinal side 46, 48 which faces the working face 8. In addition or as an alternative, the additional-frame module 61 and/or the end-side plate 45 may be fastened releasably to the pan outer longitudinal side 46 or 48 which faces away from the working face 8.

According to a further aspect, the releasable fastenings of the individual modules make dismantling of the course crusher 18 possible, with the result that the said coarse crusher 18 may be moved to the next location of use in a simple way in an at least partially dismantled state. In addition, the coarse crusher 20 may be easier to maintain. Moreover, individual modules may be exchanged in a simple way. This may be necessary, for example, if a certain module is damaged, is to be serviced or an improved module is available.

In the embodiments, in which at least one part, for example the pan module 20, has fastening apparatuses on both sides or may be fastened, the modular design is not restricted to all the parts of the coarse crusher 18 having to be capable of being fastened on both sides. For example, in one embodiment, merely the pan module 20 may have first and/or second pan fastening apparatuses 50 on both pan outer longitudinal sides 46, 48. In an alternative or additional embodiment, in addition, the support-arm module 24, as described with reference to FIGS. 7 and 8, may be capable of being mounted in the base-frame module 22 on both sides. In a further alternative or additional embodiment, the base-frame module 22, as described with reference to FIGS. 5 and 6, may be capable of being mounted on both sides.

In the embodiments, in which a component, for example the base-frame module 22, may be fastened releasably only on one side, it is necessary for a mirror-image construction of the coarse crusher 18 to provide the said component in a second embodiment for mirror-image mounting.

The required number of parts for mirror-image attachments of the coarse crusher 18 may be reduced by an increase in the number of modules which may be fastened releasably on both sides and, in addition, are designed in such a way that they may perform their function in both installation positions.

It is made possible that an extraction machine 2 may move as far as a section of the working face 8 opposite the face ends 5, 6 of the face conveyor 4 by virtue of the fact that the coarse crusher 18 has a plurality of second pan fastening apparatuses 52 for fastening the guide segment 30 releasably for guiding the extraction machine 2. The transition between face and gate may be cut free by the extraction machine 2 which may move as far as the guide segment 30 on the coarse crusher 18 which is arranged at one of the face ends 5, 6.

Although the preferred embodiments of this invention have been described herein, improvements and modifications may be incorporated without departing from the scope of the following claims.

1. A coarse crusher for use at both face ends of a face conveyor in an underground mine, the coarse crusher comprising:
a pan module with a strand segment for guiding an endless conveying means, the strand segment being delimited by a first pan outer longitudinal side and a second pan outer longitudinal side which lies opposite the first pan outer longitudinal side, the first pan outer longitudinal side and the second pan outer longitudinal side including a plurality of first pan fastening apparatuses;
a base-frame module fastened releasably via the corresponding first pan fastening apparatuses to one of the first pan outer longitudinal side and the second pan outer longitudinal side; and
a support-arm module fastened releasably to the base-frame module.

2. The coarse crusher according to claim 1, wherein the pan module includes a plurality of second pan fastening apparatuses both on the first pan outer longitudinal side and on the second pan outer longitudinal side, and the coarse crusher further comprises:
a guide segment configured to guide an extraction machine, the guide segment fastened releasably via the second pan fastening apparatuses to an other one of the first pan outer longitudinal side and the second pan outer longitudinal side.

3. The coarse crusher according to claim 1, wherein the pan module is substantially wedge-shaped.

4. The coarse crusher according to claim 1, wherein the first pan fastening apparatuses of the first pan outer longitudinal side and the first pan fastening apparatuses of the second pan outer longitudinal side are arranged substantially mirror-symmetrically.

5. The coarse crusher according to claim 2, wherein the second pan fastening apparatuses of the first pan outer longitudinal side and the second pan fastening apparatuses of the second pan outer longitudinal side are arranged substantially mirror-symmetrically.

6. The coarse crusher according to claim 1, wherein the first pan outer longitudinal side and the second pan outer longitudinal side are of substantially mirror-symmetrical configuration.

7. The coarse crusher according to claim 1, wherein the support-arm module is fastened pivotably via a first pivot pin to the base-frame module.

8. The coarse crusher according to one of the preceding claims, wherein the support-arm module is fastened to the base-frame module in a height-adjustable manner via a guide in the base-frame module.

9. The coarse crusher according to one of the preceding claims, further comprising a hydraulic cylinder, in which a piston rod is guided, the piston rod being fastened pivotably via a second pivot pin to the support-arm module, and the hydraulic cylinder being fastened pivotably via a third pivot pin to the base-frame module.

10. The coarse crusher according to claim 9, wherein the support-arm module includes at least one of a first through hole for receiving the first pivot pin, a second through hole for receiving the second pivot pin, and a third through hole for receiving a fourth pivot pin.

11. The coarse crusher according to claim 1, wherein the support-arm module includes a support-arm body which is delimited by a first support-arm outer longitudinal side and a second support-arm outer longitudinal side which lies opposite the first support-arm outer longitudinal side, the first support-arm outer longitudinal side being of substantially mirror-symmetrical configuration with respect to the second support-arm outer longitudinal side.

12. The coarse crusher according to claim 1, wherein the base-frame module includes a frame body which is delimited by a first base-frame outer longitudinal side and a second base-frame outer longitudinal side which lies opposite the first base-frame outer longitudinal side, both the first base-frame outer longitudinal side and the second base-frame outer longitudinal side having a plurality of frame fastening apparatuses, and the frame fastening apparatuses of the first base-frame outer longitudinal side and the frame fastening apparatuses of the second base-frame outer longitudinal side being arranged substantially mirror-symmetrically.

13. The coarse crusher according to claim 12, wherein the first base-frame outer longitudinal side and the second base-frame outer longitudinal side are of substantially mirror-symmetrical configuration.

14. The coarse crusher according to claim 1, wherein the base-frame module is fastened releasably via a plurality of fasteners to the plurality of first pan fastening apparatuses.

15. The coarse crusher according to claim 1, further comprising:
an end-side plate fastened releasably to the one of the first pan outer longitudinal side and second pan outer longitudinal side.

16. The core crusher according to claim 1 further including a cutting drum apparatus fastened releasably to the support arm module.

17. A mining system, comprising:
an extraction machine configured to extract material from a wall;
a face conveyor configured to move the material away from the extraction machine; and
a coarse crusher configured to crush the material, the coarse crusher including:
a pan module having a strand segment configured to guide an endless conveying means, the strand segment being delimited by a first pan outer longitudinal side and a second pan outer longitudinal side opposite the first pan outer longitudinal side, the first pan outer longitudinal side and the second pan outer longitudinal side including a plurality of first pan fastening apparatuses;
a base-frame module fastened releasably via the corresponding first pan fastening apparatuses to the first pan outer longitudinal side; and
a support-arm module fastened releasably to the base-frame module.

18. The mining system according to claim 17, wherein the pan module includes a plurality of second pan fastening apparatuses both on the first pan outer longitudinal side and on the second pan outer longitudinal side, and the coarse crusher further includes a guide segment configured to guide an extraction machine, the guide segment being fastened releasably via the second pan fastening apparatuses to the second pan outer longitudinal side.

19. The mining system according to claim 17, wherein the support-arm module is fastened pivotably via a first pivot pin to the base-frame module.

20. The mining system according to claim 17, further including an end-side plate fastened releasably to the first pan outer longitudinal side.
